(19) United States
(12) Patent Application Publication
(10) Pub. No.: US 2016/0358208 A1
(43) Pub. Date: Dec. 8, 2016

(54) METHOD, DEVICE, SYSTEM FOR DISPLAYING MEDIA DATA

(71) Applicant: TENCENT TECHNOLOGY (SHENZHEN) COMPANY LIMITED, Shenzhen, Guangdong (CN)

(72) Inventors: Dongbo Huang, Shenzhen (CN); Ge Chen, Shenzhen (CN); Hongyu Zhao, Shenzhen (CN); Chaojian Zhou, Shenzhen (CN)

(21) Appl. No.: 15/100,840

(22) PCT Filed: Feb. 16, 2015
(86) PCT No.: PCT/CN2015/073198

§ 371 Date: Jun. 1, 2016

(30) Foreign Application Priority Data
Feb. 28, 2014 (CN) 201410071841.1

(51) Int. Cl. G06Q 30/02; H04L 29/08

(52) U.S. Cl. CPC G06Q 30/0246; G06Q 30/0277; G06Q 30/0255; H04L 67/22

(57) ABSTRACT

The present disclosure discloses a method, a device, and a system for displaying media data, which belong to the field of information processing technologies. The method includes: determining at least one piece of media data corresponding to a data display position; acquiring predicted click information and predicted display information corresponding to each piece of media data; and selecting one piece of media data from all the media data according to the predicted click information and the predicted display information corresponding to each piece of media data and displaying the selected media data on the data display position. In the present disclosure, by determining predicted click information and predicted display information corresponding to at least one piece of media data corresponding to a data display position, selecting one piece of media data from all the media data according to the predicted click information and the predicted display information corresponding to each piece of media data and displaying the selected media data on the data display position, a decrease in the click-through rate of the displayed media data due to that a current user is not interested in the media data displayed currently is prevented, and a display effect of the media data is enhanced.

### FIELD OF THE TECHNOLOGY

The present disclosure relates to the field of information processing technologies, and in particular, to a method, a device, and a system for displaying media data.

### BACKGROUND OF THE DISCLOSURE

Currently, with the wide use of information processing technologies, applications based on Internet technologies emerge one after another. With an increase in users of a certain application, an operator of the application may provide a service of displaying media data in the application and use the service as a new marketing approach, so as to increase revenues of the application. For example, at least one data display position is added in the application, a piece of media data is selected from media data that can be displayed, and the selected media data is displayed on the data display position. Because displaying different media data brings different revenues, how to select media data to be displayed so that display of the media data barely affects or does not affect the user experience at all while bringing a maximum revenue becomes a key to maximizing the commercial profit of traffic by the operator without losing users.

An existing method for displaying media data is: determining, according to the volume of media data that can be displayed on a data display position, media data to be displayed, and displaying, on the data display position within a preset duration, the media data in turn on the condition that the total number of times each piece of media data is displayed on the data display position is the same. Specifically, the preset duration is equally divided into a plurality of sub durations in chronological order, and one piece of media data is selected from all the media data and displayed in each sub duration. To ensure that each piece of media data is displayed for the same total number of times, for any one of the sub durations, one piece of media data is selected from all the media data in an equal-probability random manner.

During the implementation of the present disclosure, the inventor finds that the prior art at least has the following disadvantages:

By selecting media data from all the media data in an equal-probability random manner, although it is ensured that the total number of times each piece of media data is displayed is the same, a current user will not be interested in media data displayed currently if the current user does not belong to a user group of the media data displayed currently; therefore, a click-through rate of the media data is low and a display effect of the media data is affected.

### SUMMARY

To solve the problem in the existing technology, embodiments of the present invention provide a method, a device, and a system for displaying media data. The technical solution is as follows:

In a first aspect, a method for displaying media data is provided, the method including:

determining at least one piece of media data corresponding to a data display position;

acquiring predicted click information and predicted display information corresponding to each piece of media data; and

selecting one piece of media data from all the media data according to the predicted click information and the predicted display information corresponding to each piece of media data, and displaying the selected media data on the data display position;

the predicted click information corresponding to the media data being used for describing a display effect of the media data on the data display position, and the predicted display information corresponding to the media data being used for describing the number of times the media data is displayed on all data display positions.

In a second aspect, a device for displaying media data is provided, the device including:

a determining module, configured to determine at least one piece of media data corresponding to a data display position;

a first acquiring module, configured to acquire predicted click information corresponding to each piece of media data determined by the determining module;

a second acquiring module, configured to acquire predicted display information corresponding to each piece of media data determined by the determining module;

a selecting module, configured to select one piece of media data from all the media data according to the predicted click information and the predicted display information corresponding to each piece of media data; and

a display module, configured to display the media data selected by the selecting module on the data display position;

the predicted click information corresponding to the media data being used for describing a display effect of the media data on the data display position, and the predicted display information corresponding to the media data being used for describing the number of times the media data is displayed on all data display positions.

In a third aspect, a method for displaying media data is provided, the method including:

receiving user information, data display position information, and at least one piece of media data that are sent by a device for displaying media data, and acquiring a model file;

applying the user information, the data display position information, and each piece of media data as parameters to the model file to obtain a predicted click-through rate corresponding to each piece of media data, and determining an average click-through rate corresponding to the data display position according to the predicted click-through rate corresponding to each piece of media data;

using a ratio of the predicted click-through rate corresponding to each piece of media data to the average click-through rate corresponding to the data display position as the predicted click information corresponding to each piece of media data; and

sending the predicted click information corresponding to each piece of media data to the device for displaying media data, so that the device for displaying media data selects one piece of media data from all the media data according to the predicted click information corresponding to each piece of media data and displays the selected media data on the data display position;

the model file being used for obtaining, according to an associated feature among the data display position information, the media data, and the user information of the data display position, a predicted click-through rate relative to a user when the media data is displayed on the data display position.

In a fourth aspect, a predicting device for media data display is provided, the predicting device including:

a receiving module, configured to receive user information, data display position information, and at least one piece of media data that are sent by a device for displaying media data;

a first acquiring module, configured to acquire a model file;

an application module, configured to apply the user information, the data display position information, and each piece of media data received by the receiving module as parameters to the model file acquired by the first acquiring module, to obtain a predicted click-through rate corresponding to each piece of media data;

a first determining module, configured to determine an average click-through rate corresponding to the data display position according to the predicted click-through rate corresponding to each piece of media data obtained by the application module;

a second determining module, configured to use a ratio of the predicted click-through rate corresponding to each piece of media data obtained by the application module to the average click-through rate corresponding to the data display position obtained by the first determining module as the predicted click information corresponding to each piece of media data; and

a sending module, configured to send the predicted click information corresponding to each piece of media data obtained by the second determining module to the device for displaying media data, so that the device for displaying media data selects one piece of media data from all the media data according to the predicted click information corresponding to each piece of media data and displays the selected media data on the data display position;

the model file being used for obtaining, according to an associated feature among the data display position information, the media data, and the user information of the data display position, a predicted click-through rate relative to a user when the media data is displayed on the data display position.

In a fifth aspect, a method for displaying media data is provided, the method including:

receiving a data display quantity of a data display position and at least one piece of media data that are sent by a device for displaying media data;

acquiring preset display times of each piece of media data;

computing predicted display information corresponding to each piece of media data according to the data display quantity of the data display position and the preset display times of each piece of media data; and

sending the predicted display information corresponding to each piece of media data to the device for displaying media data, so that the device for displaying media data selects one piece of media data from all the media data according to the predicted display information corresponding to each piece of media data and displays the selected media data on the data display position.

In a sixth aspect, a real-time control device for media data display is provided, the real-time control device including:

a receiving module, configured to receive a data display quantity of a data display position and at least one piece of media data that are sent by a device for displaying media data;

an acquiring module, configured to acquire preset display times of each piece of media data;

a computing module, configured to compute predicted display information corresponding to each piece of media data according to the data display quantity of the data display position and the preset display times of each piece of media data; and

a sending module, configured to send the predicted display information corresponding to each piece of media data obtained by the computing module to the device for displaying media data, so that the device for displaying media data selects one piece of media data from all the media data according to the predicted display information corresponding to each piece of media data and displays the selected media data on the data display position.

In a seventh aspect, a system for displaying media data is provided, the system including: a device for displaying media data, a predicting device, and a real-time control device;

the device for displaying media data being the device for displaying media data provided in the second aspect, the predicting device being the predicting device for media data display provided in the fourth aspect, and the real-time control device being the real-time control device for media data display provided in the sixth aspect.

The technical solution provided in the embodiments of the present invention brings the following beneficial effects:

By selecting one piece of media data from all media data according to predicted click information and predicted display information corresponding to each piece of media data, and displaying the selected media data on a data display position, it is ensured, by using the predicted click information corresponding to the media data, that a click-through rate obtained when the selected media data is displayed on the data display position is higher than a click-through rate obtained when any other piece of media data is displayed on the data display position, while it is ensured, by using the predicted display information corresponding to the media data, that the total number of times each piece of media data is displayed is the same, so as to prevent a decrease in the click-through rate of the displayed media data due to that a current user is not interested in the media data displayed currently, thereby enhancing a display effect of the media data.

### BRIEF DESCRIPTION OF THE DRAWINGS

To describe the technical solutions of the embodiments of the present invention more clearly, the following briefly introduces the accompanying drawings required for describing the embodiments. Apparently, the accompanying drawings in the following description show only some embodiments of the present invention, and a person of ordinary skill in the art may still derive other drawings from these accompanying drawings without creative efforts.

FIG. 1 is a schematic diagram of an implementation environment of a method for displaying media data according to an embodiment of the present invention;

FIG. 2 is a flowchart of a first method for displaying media data according to Embodiment 1 of the present invention;

FIG. 3 is a flowchart of a second method for displaying media data according to Embodiment 1 of the present invention;

FIG. 4 is a flowchart of a third method for displaying media data according to Embodiment 1 of the present invention;

FIG. 5 is a flowchart of a method for displaying media data according to Embodiment 2 of the present invention;

FIG. 6 is a schematic flowchart of predicting a click-through rate lifting ratio by a predicting device according to Embodiment 2 of the present invention;

FIG. 7 is a schematic flowchart of displaying, by a device for displaying media data, media data according to Embodiment 2 of the present invention;

FIG. 8 is a schematic structural diagram of a device for displaying media data according to Embodiment 3 of the present invention;

FIG. 9 is a schematic structural diagram of a first-type first acquiring module according to Embodiment 3 of the present invention;

FIG. 10 is a schematic structural diagram of a second-type first acquiring module according to Embodiment 3 of the present invention;

FIG. 11 is a schematic structural diagram of a third-type first acquiring module according to Embodiment 3 of the present invention;

FIG. 12 is a schematic structural diagram of a first-type second acquiring module according to Embodiment 3 of the present invention;

FIG. 13 is a schematic structural diagram of a second type of the second acquiring module according to the Embodiment 3 of the present invention;

FIG. 14 is a schematic structural diagram of a selecting module according to the Embodiment 3 of the present invention;

FIG. 15 is a schematic structural diagram of a computing submodule according to Embodiment 3 of the present invention;

FIG. 16 is a schematic structural diagram of a first-type predicting device according to Embodiment 4 of the present invention;

FIG. 17 is a schematic structural diagram of a second-type predicting device according to Embodiment 4 of the present invention;

FIG. 18 is a schematic structural diagram of a first-type real-time control device according to Embodiment 5 of the present invention;

FIG. 19 is a schematic structural diagram of a system for displaying media data according to Embodiment 6 of the present invention; and

FIG. 20 is a schematic structural diagram of a server for displaying media data according to Embodiment 7 of the present invention.

### DESCRIPTION OF EMBODIMENTS

To make the objectives, technical solutions, and advantages of the present invention more clear, specific implementation manners of the present disclosure are further described in detail below with reference to the accompanying drawings.

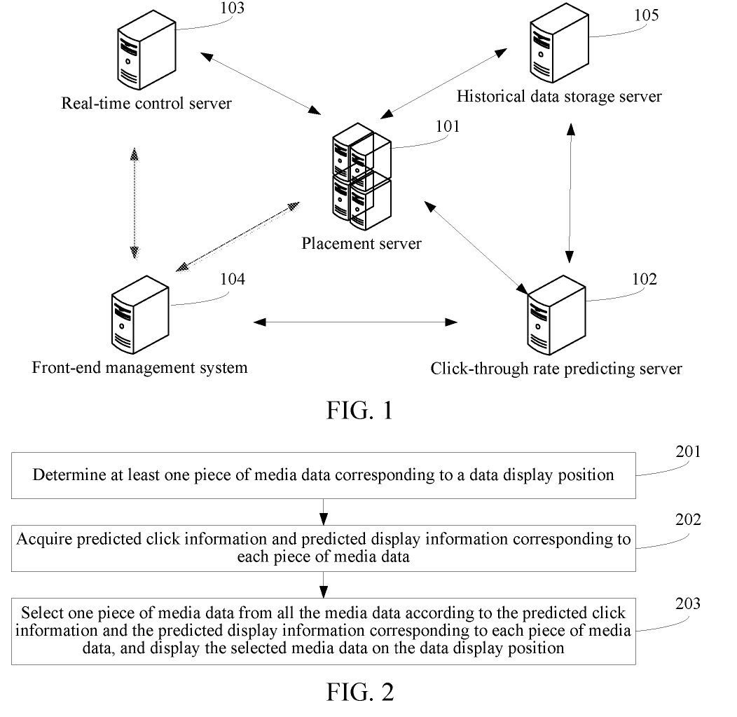

Referring to FIG. 1, FIG. 1 is a schematic diagram of an implementation environment of a method for displaying media data according to an embodiment of the present invention. The implementation environment includes a placement server 101, a click-through rate predicting server 102, a real-time control server 103, a front-end management system 104, and a historical data storage server 105.

The placement server 101 may display media data by using the method for displaying media data provided in the embodiment of the present invention.

The click-through rate predicting server 102 is configured to provide the placement server 101 with a computing service of computing predicted click information corresponding to each piece of media data.

The real-time control server 103 is configured to provide the placement server 101 with a computing service of computing predicted display information corresponding to each piece of media data.

The front-end management system 104 is configured to provide information such as data display position information of each current data display position, user information, each piece of media data, and preset display times corresponding to each piece of media data for the placement server 101, provide information such as data display position information of all data display positions for the click-through rate predicting server 102, and provide information such as preset display times corresponding to each piece of media data for the real-time control server 103.

The historical data storage server 105 is configured to provide information such as data display position information of all data display positions, historical displayed media data, and historical user information for the placement server 101, and provide information such as historical displayed media data and historical user information for the click-through rate predicting server 102.

### Embodiment 1

This embodiment provides a method for displaying media data. Referring to FIG. 2, a process of the method provided in this embodiment is specifically as follows:

201: Determine at least one piece of media data corresponding to a data display position.

202: Acquire predicted click information and predicted display information corresponding to each piece of media data.

The predicted click information corresponding to the media data is used for describing a display effect of the media data on the data display position, and the predicted display information corresponding to the media data is used for describing the number of times the media data is displayed on all data display positions.

Preferably, data display position information, user information, and a model file that are corresponding to the data display position are acquired.

The data display position information, the user information, and each piece of media data that are corresponding to the data display position are applied as parameters to the model file to obtain a predicted click-through rate corresponding to each piece of media data, and an average click-through rate corresponding to the data display position is determined according to the predicted click-through rate corresponding to each piece of media data.

A ratio of the predicted click-through rate corresponding to each piece of media data to the average click-through rate corresponding to the data display position is used as the predicted click information corresponding to each piece of media data.

The model file is used for obtaining, according to an associated feature among the data display position information, the media data, and the user information of the data display position, a predicted click-through rate relative to a user when the media data is displayed on the data display position.

Preferably, before the acquiring data display position information, user information, and a model file that are corresponding to the data display position, the method further includes:

acquiring data display position information, historical displayed media data, and historical user information of each data display position; and

acquiring the associated feature among the data display position information, the media data, and the user information according to the data display position information, the historical displayed media data, and the historical user information of each data display position, and forming a model file in which the data display position information, the media data, and the user information are used as parameters, the associated feature among the data display position information, the media data, and the user information is used as a model, and the predicted click-through rate relative to the user when the media data is displayed on the data display position is used as an output result.

Optionally, the acquiring predicted click information corresponding to each piece of media data includes:

acquiring user information and data display position information that are corresponding to the data display position;

sending the user information, the data display position information, and each piece of media data that are corresponding to the data display position to a predicting device, so that the predicting device predicts and returns the predicted click information corresponding to each piece of media data according to the user information, the data display position information, and each piece of media data that are corresponding to the data display position; and

receiving the predicted click information corresponding to each piece of media data returned by the predicting device.

Preferably, the acquiring predicted display information corresponding to each piece of media data includes:

acquiring preset display times of each piece of media data; and

computing the predicted display information corresponding to each piece of media data according to a data display quantity of the data display position and the preset display times of each piece of media data.

Preferably, the computing the predicted display information corresponding to each piece of media data according to a data display quantity of the data display position and the preset display times of each piece of media data includes:

computing the predicted display information corresponding to each piece of media data according to the data display quantity of the data display position and the preset display times of each piece of media data based on the following formula:

$$predicted display information [ i ] = \frac{{Σ}_{i = 1}^{N} display times [ i ]}{N \times display times [ i ]} ;$$

where the predicted display information [i] is predicted display information corresponding to media data i, the display times [i] is preset display times of the media data i, and N is the data display quantity of the data display position.

Optionally, the acquiring predicted display information corresponding to each piece of media data includes:

sending a data display quantity of the data display position and each piece of media data to a real-time control device, so that the real-time control device determines and returns the predicted display information corresponding to each piece of media data according to the data display quantity of the data display position; and

receiving the predicted display information corresponding to each piece of media data returned by the real-time control device.

203: Select one piece of media data from all the media data according to the predicted click information and the predicted display information corresponding to each piece of media data, and display the selected media data on the data display position.

Preferably, the selecting media data from all the media data according to the predicted click information and the predicted display information corresponding to each piece of media data includes:

computing a display index value corresponding to each piece of media data according to the predicted click information and the predicted display information corresponding to each piece of media data; and

determining a largest display index value among all display index values corresponding to all the media data, and using media data corresponding to the largest display index value as the selected media data.

Preferably, the computing a display index value corresponding to each piece of media data according to the predicted click information and the predicted display information corresponding to each piece of media data includes:

acquiring a predicted click information adjustment parameter α and a predicted display information adjustment parameter β; and

computing the display index value corresponding to each piece of media data according to the predicted click information and the predicted display information corresponding to each piece of media data based on the following formula:

F[i]=(predicted click information [i])^{α}×(predicted display information [i])^{β};

where F[i] is a display index value corresponding to media data i, the predicted click information [i] is predicted click information corresponding to the media data i, and the predicted display information [i] is predicted display information corresponding to the media data i.

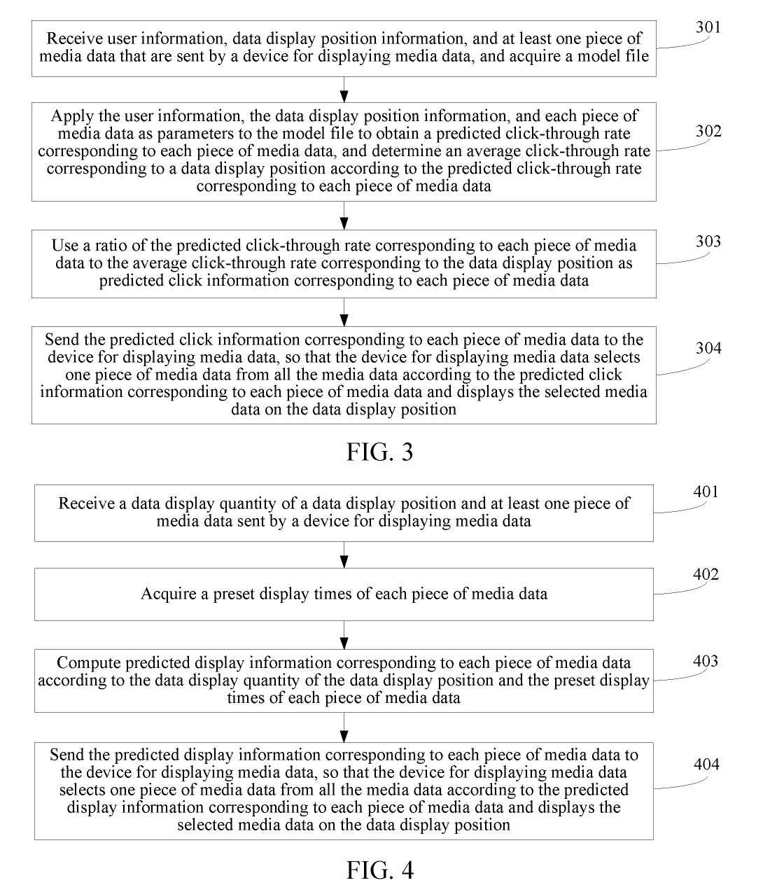

This embodiment further provides a second method for displaying media data. Referring to FIG. 3, a process of the method provided in this embodiment is specifically as follows:

301: Receive user information, data display position information, and at least one piece of media data that are sent by a device for displaying media data, and acquire a model file.

The model file is used for obtaining, according to an associated feature among the data display position information, the media data, and the user information of a data display position, a predicted click-through rate relative to a user when the media data is displayed on the data display position.

Preferably, before the acquiring a model file, the method further includes:

acquiring data display position information, historical displayed media data, and historical user information of each data display position; and

acquiring the associated feature among the data display position information, the media data, and the user information according to the data display position information, the historical displayed media data, and the historical user information of each data display position, and forming a model file in which the data display position information, the media data, and the user information are used as parameters, the associated feature among the data display position information, the media data, and the user information is used as a model, and the predicted click-through rate relative to the user when the media data is displayed on the data display position is used as an output result.

302: Apply the user information, the data display position information, and each piece of media data as parameters to the model file to obtain a predicted click-through rate corresponding to each piece of media data, and determine an average click-through rate corresponding to the data display position according to the predicted click-through rate corresponding to each piece of media data.

303: Use a ratio of the predicted click-through rate corresponding to each piece of media data to the average click-through rate corresponding to the data display position as predicted click information corresponding to each piece of media data.

304: Send the predicted click information corresponding to each piece of media data to the device for displaying media data, so that the device for displaying media data selects one piece of media data from all the media data according to the predicted click information corresponding to each piece of media data and displays the selected media data on the data display position.

This embodiment further provides a third method for displaying media data. Referring to FIG. 4, a process of the method provided in this embodiment is specifically as follows:

401: Receive a data display quantity of a data display position and at least one piece of media data that are sent by a device for displaying media data.

402: Acquire preset display times of each piece of media data.

403: Compute predicted display information corresponding to each piece of media data according to the data display quantity of the data display position and the preset display times of each piece of media data.

Preferably, the computing predicted display information corresponding to each piece of media data according to the data display quantity of the data display position and the preset display times of each piece of media data includes:

computing the predicted display information corresponding to each piece of media data according to the data display quantity of the data display position and the preset display times of each piece of media data based on the following formula:

$$predicted display information [ i ] = \frac{{Σ}_{i = 1}^{N} display times [ i ]}{N \times display times [ i ]} ;$$

where the predicted display information [i] is predicted display information corresponding to media data i, the display times [i] is preset display times of the media data i, and N is the data display quantity of the data display position.

404: Send the predicted display information corresponding to each piece of media data to the device for displaying media data, so that the device for displaying media data selects one piece of media data from all the media data according to the predicted display information corresponding to each piece of media data and displays the selected media data on the data display position.

By selecting one piece of media data from all media data according to predicted click information and predicted display information corresponding to each piece of media data and displaying the selected media data on a data display position, the method provided in this embodiment ensures, by using the predicted click information corresponding to the media data, a click-through rate obtained when the selected media data is displayed on the data display position is higher than a click-through rate obtained when any other piece of media data is displayed on the data display position, while ensuring, by using the predicted display information corresponding to the media data, that the total number of times each piece of media data is displayed is the same, so as to prevent a decrease in the click-through rate of the displayed media data due to that a current user is not interested in the media data displayed currently, thereby enhancing a display effect of the media data.

To explain the method for displaying media data provided in the foregoing embodiment more clearly, the method for displaying media data is described in detail with reference to the content disclosed in the foregoing embodiment and by using Embodiment 2 below as an example. For details, refer to Embodiment 2 below:

### Embodiment 2

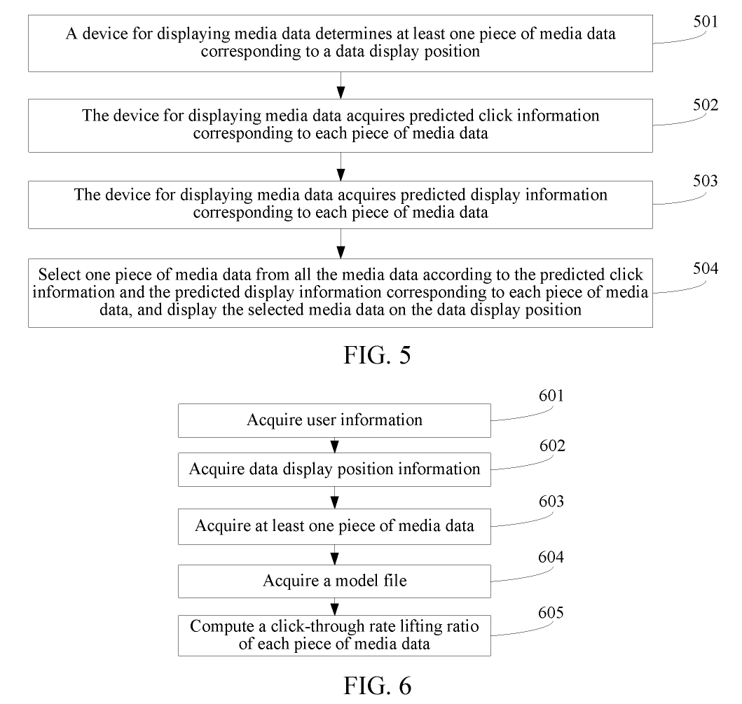

This embodiment provides a method for displaying media data. For ease of description, this embodiment describes the method provided in this embodiment in detail by using an example in which a device for displaying media data is the placement server 101 in FIG. 1, a predicting device is the click-through rate predicting server 102 in FIG. 1, a real-time control device is the real-time control server 103 in FIG. 1, data display positions are an advertisement playing position A and an advertisement playing position B, media data corresponding to the advertisement playing position A is an advertisement A and an advertisement B, and media data corresponding to the advertisement playing position B is an advertisement C and an advertisement D. Referring to FIG. 5, a process of the method provided in this embodiment is as follows:

501: A device for displaying media data determines at least one piece of media data corresponding to a data display position.

In specific implementation of this step, either of the following two implementation manners can be used to determine at least one piece of media data corresponding to the data display position.

First implementation manner: Determine all media data corresponding to the data display position and select at least one piece of media data from all the media data as media data corresponding to the data display position.

Second implementation manner: Determine all media data corresponding to the data display position and use all the media data corresponding to the data display position as media data corresponding to the data display position.

Besides, other implementation manners may also be used to determine at least one piece of media data corresponding to the data display position. This embodiment does not limit the specific implementation manner in which the device for displaying media data determines at least one piece of media data corresponding to the data display position.

A specific implementation method of the first implementation manner, namely, determining all media data corresponding to the data display position and selecting at least one piece of media data from all the media data as media data corresponding to the data display position, may include the following three steps.

First step: Acquire a data display quantity of the data display position.

Because the number of pieces of media data that can be displayed on a data display position, that is, a data display quantity, is defined when the data display position is set, the data display quantity of the data display position may be acquired according to setting information of the data display position. Besides, other methods may also be used to acquire the data display quantity of the data display position. This embodiment does not limit the specific acquiring method for acquiring the data display quantity of the data display position.

For example, in FIG. 1, the placement server 101 acquires a setting A of the advertisement playing position A and a setting B of the advertisement playing position B by using the front-end management system 104, acquires a data display quantity, which is 1, of the advertisement playing position A by using the setting A, and acquires a data display quantity, which is 3, of the advertisement playing position B by using the setting B.

Certainly, the specific data display quantity of the advertisement playing position A or the advertisement playing position B may also be other values. This embodiment does not limit the specific data display quantity of the advertisement playing position A or the advertisement playing position B.

Second step: Select at least one piece of media data from all the media data corresponding to the data display position according to the data display quantity.

This embodiment does not limit the specific manner of selecting at least one piece of media data from all the media data corresponding to the data display position according to the data display quantity, and the specific manner includes, but not is limited to, selecting at least one piece of media data from all the media data corresponding to the data display position according to the data display quantity by using the following four sub-steps.

First sub-step: Determine the number of pieces of media data.

A provider of media data determines, when determining to display the media data, a display condition of the media data, and a data display position satisfying the display condition can be determined according to the display condition, and therefore, a correspondence exists between the media data and the data display position. Therefore, when all the media data corresponding to the data display position is used as the media data corresponding to the data display position, the number of different pieces of media data corresponding to the data display position is the number of pieces of media data. Besides, other methods may also be used to determine the number of pieces of media data. This embodiment does not limit the manner of determining the number of pieces of media data.

For example, in FIG. 1, by using the front-end management system 104, the placement server 101 acquires the media data corresponding to the advertisement playing position A, which is the advertisement A and the advertisement B, and uses both the advertisement A and the advertisement B as the media data corresponding to the advertisement playing position A, the number of pieces of media data of the advertisement playing position A being 2; and acquires the media data corresponding to the advertisement playing position B, which is the advertisement C and the advertisement D, and uses both the advertisement C and the advertisement D as the media data corresponding to the advertisement playing position B, the number of pieces of media data of the advertisement playing position B being 2. Certainly, the number of pieces of media data corresponding to the advertisement playing position A or the advertisement playing position B may also be other values. This embodiment does not limit the specific value of the number of pieces of media data corresponding to the advertisement playing position A or the advertisement playing position B.

Second sub-step: Determine whether the data display quantity is greater than the number of pieces of media data; if the data display quantity is not greater than the number of pieces of media data, perform third sub-step; or if the data display quantity is greater than the number of pieces of media data, perform fourth sub-step.

Specifically, for the advertisement playing position A, the placement server 101 acquires the data display quantity of the advertisement playing position A, which is 1, and the number of pieces of media data of the advertisement playing position A, which is 2, and determines that, at the advertisement playing position A, the data display quantity, which is 1, is not greater than the number of pieces of media data, which is 2; and the placement server 101 acquires the data display quantity of the advertisement playing position B, which is 3, and the number of pieces of media data of the advertisement playing position B, which is 2, and determines that, at the advertisement playing position B, the data display quantity, which is 3, is greater than the number of pieces of media data, which is 2.

Third sub-step: Select, from the media data corresponding to the data display position, media data of which the number of pieces is equal to the data display quantity.

This embodiment does not limit the specific selection basis for selecting, from the media data corresponding to the data display position, media data of which the number of pieces is equal to the data display quantity. For example, media data of which the number of pieces is equal to the data display quantity is randomly selected from the media data corresponding to the data display position.

For example, one advertisement is randomly selected from the advertisement A and the advertisement B corresponding to the advertisement playing position A, for instance, the advertisement A is selected.

Fourth sub-step: Use all the media data corresponding to the data display position as selected media data.

For example, the advertisement C and the advertisement D corresponding to the advertisement playing position B are both used as selected media data.

Third step: Use the selected at least one piece of media data as the media data corresponding to the data display position.

For example, if the selected media data corresponding to the advertisement playing position A is the advertisement A, the advertisement A is used as the media data corresponding to the advertisement playing position A; if the selected media data corresponding to the advertisement playing position B is the advertisement C and the advertisement D, the advertisement C and the advertisement D are both used as the media data corresponding to the advertisement playing position B.

A specific implementation method of the second implementation manner, namely, determining all media data corresponding to the data display position and using all the media data corresponding to the data display position as media data corresponding to the data display position, is described by using the following example.

For example, it is determined that all media data corresponding to the advertisement playing position A is the advertisement A and the advertisement B, and the advertisement A and the advertisement B are both used as the media data corresponding to the advertisement playing position A; it is determined that all media data corresponding to the advertisement playing position B is the advertisement C and the advertisement D, and the advertisement C and the advertisement D are both used as the media data corresponding to the advertisement playing position B.

502: The device for displaying media data acquires predicted click information corresponding to each piece of media data.

A click-through rate lifting ratio corresponding to the media data is a lifting ratio of a predicted click-through rate with respect to a current user when the media data is displayed on the data display position to an average predicted click-through rate with respect to other users when the media data is displayed on the data display position. Therefore, the click-through rate lifting ratio corresponding to the media data can be used as the predicted click information corresponding to the media data. Besides, another parameter capable of reflecting the predicted click information corresponding to the media data can also be used as the predicted click information corresponding to the media data. This embodiment does not limit the specific parameter of the predicted click information corresponding to the media data.

The current user is a current user corresponding to the data display position when the device for displaying media data uses the method for displaying media data provided in this embodiment, and the other users are all users corresponding to the data display position. The click-through rate lifting ratio corresponding to the media data is used to describe a display effect of the media data on the data display position, so as to prevent the problem that the predicted click-through rate of the media data is constantly high because only the click-through rate is predicted.

A specific method for acquiring the click-through rate lifting ratio corresponding to each piece of media data by the device for displaying media data varies when different specific devices are used to compute the click-through rate lifting ratio corresponding to each piece of media data. This embodiment does not limit the specific acquiring method for acquiring the click-through rate lifting ratio corresponding to each piece of media data by the device for displaying media data.

For example, if the specific device which computes the click-through rate lifting ratio corresponding to each piece of media data is the device for displaying media data, the device for displaying media data acquires the click-through rate lifting ratio corresponding to each piece of media data by using the following five steps.

Step 1: Acquire data display position information, historical displayed media data, and historical user information of each data display position.

The data display position information is used for describing an attribute of the data display position, and includes: a location of the data display position, an industry corresponding to an application to which the data display position pertains, and the like. The historical displayed media data is used for describing an attribute of historical media data displayed on the data display position, and includes: an industry to which the historical media data pertains, the volume of the historical media data, and the like. The historical user information is used for describing information of a historical user corresponding to the data display position, and includes: the age of the historical user, a work field of the historical user, and the like. Certainly, the data display position information may further include other content. This embodiment does not limit the content specifically included in the data display position information. The historical media data may further include other content. This embodiment does not limit the content specifically included in the historical media data. The historical user information may further include other content. This embodiment does not limit the content specifically included in the historical user information.

This embodiment does not limit the specific acquiring manner of acquiring the data display position information, the historical displayed media data, and the historical user information of each data display position, and the specific acquiring manner includes, but is not limited to: acquiring, by the device for displaying media data, the data display position information, the historical displayed media data, and the historical user information of each data display position from a storage device that stores historical data.

For example, as shown in FIG. 1, the placement server 101 acquires the data display position information of each data display position from the front-end management system 104 and acquires the historical displayed media data and the historical user information from the historical data storage server 105.

Step 2: Acquire an associated feature among the data display position information, the media data, and user information according to the data display position information, the historical displayed media data, and the historical user information of each data display position, and form a model file in which the data display position information, the media data, and the user information are used as parameters, the associated feature among the data display position information, the media data, and the user information is used as a model and the predicted click-through rate relative to the user when the media data is displayed on the data display position is used as an output result.

The model file is used for obtaining, according to the associated feature among the data display position information, the media data, and the user information of the data display position, the predicted click-through rate relative to the user when the media data is displayed on the data display position. The associated feature among the data display position information, the media data, and the user information is used for describing a degree of an interest that a user corresponding to each piece of user information has in each piece of media data when each piece of media data is displayed on the data display position corresponding to the data display position information. Media data with a higher degree of interest may obtain a higher click-through rate. Therefore, the predicted click-through rate relative to the user corresponding to each piece of user information when each piece of media data is displayed on the data display position corresponding to the media data can be reflected by using the associated feature among the data display position information, the media data, and the user information.

This embodiment does not limit the specific acquiring manner of acquiring the associated feature among the data display position information, the media data, and the user information according to the data display position information, the historical displayed media data, and the historical user information of each data display position. The specific acquiring manner includes, but is not limited to: applying the data display position information, the historical displayed media data, and the historical user information of each data display position to a MapReduce-based large-scale logic regression model training system for training to obtain the associated feature among the data display position information, the media data, and the user information.

This embodiment does not limit the specific forming manner of forming a model file in which the data display position information, the media data, and the user information are used as parameters, the associated feature among the data display position information, the media data, and the user information is used as a model, and the predicted click-through rate relative to the user when the media data is displayed on the data display position is used as an output result either. The specific forming manner includes, but is not limited to: applying, according to the associated feature among the data display position information, the media data, and the user information, the data display position information, the historical displayed media data, and the historical user information of each data display position to a MapReduce-based large-scale logic regression model training system for training to obtain a model file in which the data display position information, the media data, and the user information are used as parameters, the associated feature among the data display position information, the media data, and the user information is used as a model, and the predicted click-through rate relative to the user when the media data is displayed on the data display position is used as an output result.

It should be noted that, when the method provided in this embodiment is performed, it is unnecessary to perform step 1 and step 2 each time, that is, the steps are performed when the method for displaying media data provided in this embodiment is used for the first time and the model file formed in step 1 and step 2 can be used directly in a subsequent operation of displaying media data, so as to continue to perform the following steps. However, step 1 and step 2 may be performed again at intervals of a preset time, so as to update the model file. The preset time may be of any time length. This embodiment does not limit the specific value of the preset time, and similarly, this embodiment does not limit the specific condition for triggering step 1 and step 2 again.

Step 3: Acquire the data display position information, the user information, and the model file that are corresponding to the data display position.

For example, the placement server 101 acquires the data display position information and the user information that are corresponding to the data display position from the front-end management system 104 and acquires the model file that is formed by the placement server 101 by using step 1 and step 2. Besides, a specific method for acquiring the data display position information, the user information, and the model file that are corresponding to the data display position may also be another method. This embodiment does not limit the specific method for acquiring the data display position information, the user information, and the model file that are corresponding to the data display position.

Step 4: Apply the data display position information, the user information, and each piece of media data that are corresponding to the data display position as parameters to the model file to obtain a predicted click-through rate corresponding to each piece of media data, and determine an average click-through rate corresponding to the data display position according to the predicted click-through rate corresponding to each piece of media data.

By using an example in which an advertisement playing position C is provided and it is determined in step 501 that media data corresponding to the advertisement playing position C is an advertisement E and an advertisement F, if it is obtained that a click-through rate corresponding to the advertisement E is 100 by using the data display position information, the user information, and the advertisement E that are corresponding to the advertisement playing position C as parameters in a model file, and it is obtained that a click-through rate corresponding to the advertisement F is 200 by using the data display position information, the user information, and the advertisement F that are corresponding to the advertisement playing position C as parameters in the model file, it can be determined that an average click-through rate corresponding to the advertisement playing position C is: (100+200)/2=150.

Step 5: Use a ratio of the predicted click-through rate corresponding to each piece of media data to the average click-through rate corresponding to the data display position as a click-through rate lifting ratio corresponding to each piece of media data.

Still, by using the example in step 4, 100/150=0.67 is used as the click-through rate lifting ratio corresponding to the advertisement E, and 200/150=1.33 is used as the click-through rate lifting ratio corresponding to the advertisement F.

The foregoing process only describes a manner of acquiring the click-through rate lifting ratio corresponding to each piece of media data by using an example in which the specific device that computes the click-through rate lifting ratio corresponding to each piece of media data is the device for displaying media data. In specific implementation, other manners may also be used. For example, if the specific device that computes the click-through rate lifting ratio corresponding to each piece of media data is a predicting device, the device for displaying media data may acquire the click-through rate lifting ratio corresponding to each piece of media data by using the following nine steps.

Step 1: The device for displaying media data acquires user information and data display position information that are corresponding to the data display position.

For example, as shown in FIG. 1, the placement server 101 acquires the user information and the data display position information that are corresponding to the data display position from the front-end management system 104. Besides, a specific method for acquiring the user information and the data display position information that are corresponding to the data display position may also be another method. This embodiment does not limit the specific method for acquiring the user information and the data display position information corresponding to the data display position.

Step 2: The device for displaying media data sends the user information, the data display position information, and each piece of media data that are corresponding to the data display position to the predicting device.

This embodiment does not limit the specific sending manner of sending, by the device for displaying media data, the user information, the data display position information, and each piece of media data that are corresponding to the data display position to the predicting device. For example, the device for displaying media data sends the user information, the data display position information, and each piece of media data that are corresponding to the data display position to the predicting device by sending, to the predicting device, a first message carrying the user information, the data display position information, and each piece of media data that are corresponding to the data display position.

Step 3: The predicting device acquires data display position information, historical displayed media data, and historical user information of each data display position.

This embodiment does not limit the specific acquiring manner of acquiring the data display position information, the historical displayed media data, and the historical user information of each data display position by the predicting device. The specific acquiring manner includes, but is not limited to: acquiring, by the predicting device, the data display position information, the historical displayed media data, and the historical user information of each data display position from a storage device that stores historical data.

For example, as shown in FIG. 1, the click-through rate predicting server 102 acquires the data display position information of each data display position from the front-end management system 104 and acquires the historical displayed media data and the historical user information from the historical data storage server 105.

Step 4: The predicting device acquires an associated feature among the data display position information, the media data, and the user information according to the data display position information, the historical displayed media data, and the historical user information of each data display position, and forms a model file in which the data display position information, the media data, and the user information are used as parameters, the associated feature among the data display position information, the media data, and the user information is used as a model, and the predicted click-through rate relative to the user when the media data is displayed on the data display position is used as an output result.

The model file is used for obtaining, according to the associated feature among the data display position information, the media data, and the user information of the data display position, the predicted click-through rate relative to the user when the media data is displayed on the data display position. The associated feature among the data display position information, the media data, and the user information is used for describing a degree of an interest that a user corresponding to each piece of user information has in each piece of media data when each piece of media data is displayed on the data display position corresponding to the data display position information. Media data with a higher degree of interest obtains a higher click-through rate. Therefore, the predicted click-through rate relative to the user corresponding to each piece of user information when each piece of media data is displayed on the data display position corresponding to the media data can be reflected by using the associated feature among the data display position information, the media data, and the user information.

This embodiment does not limit the specific acquiring manner of acquiring the associated feature among the data display position information, the media data, and the user information according to the data display position information, the historical displayed media data, and the historical user information of each data display position. The specific acquiring manner includes, but is not limited to: applying the data display position information, the historical displayed media data, and the historical user information of each data display position to a MapReduce-based large-scale logic regression model training system for training to obtain the associated feature among the data display position information, the media data, and the user information.

This embodiment also does not limit the specific forming manner of forming a model file in which the data display position information, the media data, and the user information are used as parameters, the associated feature among the data display position information, the media data, and the user information is used as a model, and the predicted click-through rate relative to the user when the media data is displayed on the data display position is used as an output result either. The specific forming manner includes, but is not limited to: applying, according to the associated feature among the data display position information, the media data, and the user information, the data display position information, the historical displayed media data, and the historical user information of each data display position to a MapReduce-based large-scale logic regression model training system for training to obtain a model file in which the data display position information, the media data, and the user information are used as parameters, the associated feature among the data display position information, the media data, and the user information is used as a model and the predicted click-through rate relative to the user when the media data is displayed on the data display position is used as an output result.

It should be noted that, when the method provided in this embodiment is performed, it is unnecessary to perform step 3 and step 4 each time, that is, the steps are performed when the method for displaying media data provided in this embodiment is used for the first time, and the model file formed in step 3 and step 4 can be used directly in a subsequent operation of displaying media data, so as to continue to perform the following steps. However, step 3 and step 4 may be performed again at intervals of a preset time, so as to update the model file. The preset time may be of any time length. This embodiment does not limit the specific value of the preset time, and similarly, this embodiment does not limit the specific condition for triggering step 3 and step 4 again.

Step 5: The predicting device receives the user information, the data display position information, and the at least one piece of media data that are sent by the device for displaying media data, and acquires the model file.

This embodiment does not limit the specific receiving manner of receiving, by the predicting device, the user information, the data display position information, and the at least one piece of media data that are sent by the device for displaying media data. For example, the predicting device receives the user information, the data display position information, and the at least one piece of media data that are sent by the device for displaying media data by receiving a first message that is sent by the device for displaying media data and carries the user information, the data display position information, and the at least one piece of media data that are corresponding to the data display position.

Step 6: The predicting device applies the user information, the data display position information, and each piece of media data as parameters to the model file to obtain a predicted click-through rate corresponding to each piece of media data, and determines an average click-through rate corresponding to the data display position according to the predicted click-through rate corresponding to each piece of media data.

Step 7: Use a ratio of the predicted click-through rate corresponding to each piece of media data to the average click-through rate corresponding to the data display position as a click-through rate lifting ratio corresponding to each piece of media data.

To describe the process of predicting a click-through rate lifting ratio by the predicting device more clearly and straightforwardly, reference may be made to the schematic flowchart of the process of predicting a click-through rate lifting ratio by the predicting device shown in FIG. 6 for details.

After acquiring user information in step 601, acquiring data display position information in step 602, acquiring at least one piece of media data in step 603, and acquiring a model file in step 604, the predicting device performs step 605: Compute a click-through rate lifting ratio of each piece of media data.

It should be noted that an acquisition sequence of acquiring the user information, the data display position information, the at least one piece of media data, and the model file may also be a sequence other than the sequence shown in FIG. 6. This embodiment does not limit the specific acquisition sequence of acquiring the user information, the data display position information, the at least one piece of media data, and the model file.

Step 8: The predicting device sends the click-through rate lifting ratio corresponding to each piece of media data to the device for displaying media data.

This embodiment does not limit the specific sending manner of sending, by the predicting device, the click-through rate lifting ratio corresponding to each piece of media data to the device for displaying media data. For example, the predicting device sends the click-through rate lifting ratio corresponding to each piece of media data to the device for displaying media data by sending, to the device for displaying media data, a second message carrying the click-through rate lifting ratio corresponding to each piece of media data.

Step 9: The device for displaying media data receives the click-through rate lifting ratio corresponding to each piece of media data returned by the predicting device.

This embodiment does not limit the specific receiving manner of receiving, by the device for displaying media data, the click-through rate lifting ratio corresponding to each piece of media data returned by the predicting device. For example, the device for displaying media data receives the click-through rate lifting ratio corresponding to each piece of media data returned by the predicting device by receiving a second message that is sent by the predicting device and carries the click-through rate lifting ratio corresponding to each piece of media data.

503: The device for displaying media data acquires predicted display information corresponding to each piece of media data.

Because a recommendation smooth score corresponding to media data is used for describing the number of times the media data is displayed on all data display positions, the recommendation smooth score corresponding to the media data can be used as the predicted display information corresponding to the media data. Besides, another parameter capable of reflecting the predicted display information corresponding to the media data can also be used as the predicted display information corresponding to the media data. This embodiment does not limit the specific parameter of the predicted display information corresponding to the media data.

The display times of the media data can be smoothed by using the recommendation smooth score corresponding to the media data, so that each piece of media data is displayed for the same number of times.

A specific method for acquiring the recommendation smooth score corresponding to each piece of media data by the device for displaying media data varies when different specific devices are used to compute the recommendation smooth score corresponding to each piece of media data. This embodiment does not limit the specific acquiring method for acquiring the recommendation smooth score corresponding to each piece of media data by the device for displaying media data.

For example, if the specific device that computes the recommendation smooth score corresponding to each piece of media data is the device for displaying media data, the device for displaying media data acquires the recommendation smooth score corresponding to each piece of media data by using the following four steps.

First step: Acquire preset display times corresponding to each piece of media data.

For example, as shown in FIG. 1, the placement server 101 acquires preset display times corresponding to each piece of media data from the front-end management system 104.

Second step: Compute a recommendation smooth score corresponding to each piece of media data according to the data display quantity of the data display position and the preset display times corresponding to each piece of media data.

This embodiment does not limit the specific computing method for computing the recommendation smooth score corresponding to each piece of media data according to the data display quantity of the data display position and the preset display times of each piece of media data. The specific computing method includes, but is not limited to, computing the recommendation smooth score corresponding to each piece of media data according to the following formula:

$$recommendation smooth score [ i ] = \frac{{Σ}_{i = 1}^{N} display times [ i ]}{N \times display times [ i ]} ;$$

where the recommendation smooth score [i] is a recommendation smooth score corresponding to media data i, the display times [i] is preset display times corresponding to the media data i, and N is the data display quantity of the data display position.

By using an example in which the advertisement playing position C is provided, it is determined that the media data corresponding to the advertisement playing position C is the advertisement E and the advertisement F in step 501, the data display quantity of the advertisement playing position C is 2, the preset display times corresponding to the advertisement E is 250, and the preset display times corresponding to the advertisement F is 300, the recommendation smooth score corresponding to the advertisement E=250+300/2×250=1.1 and the recommendation smooth score corresponding to the advertisement

$$F = \frac{250 + 300}{2 \times 300} 0.92 .$$

Certainly, the data display quantity of the advertisement playing position C may also be other values. This embodiment does not limit the specific data display quantity of the advertisement playing position C. The preset display times corresponding to the advertisement E or the advertisement F may also be other values. This embodiment does not limit the specific preset display times corresponding to the advertisement E and the advertisement F.

The foregoing process only describes the manner of acquiring the recommendation smooth score corresponding to each piece of media data by using an example in which the specific device that computes the recommendation smooth score corresponding to each piece of media data is the device for displaying media data. In specific implementation, other manners may also be used. For example, if the specific device that computes the recommendation smooth score corresponding to each piece of media data is a real-time control device, the device for displaying media data may acquire the recommendation smooth score corresponding to each piece of media data by using the following six steps.

First step: The device for displaying media data sends a data display quantity of the data display position and each piece of media data to the real-time control device.

This embodiment does not limit the specific sending manner of sending, by the device for displaying media data, the data display quantity of the data display position and each piece of media data to the real-time control device. For example, the device for displaying media data sends, to the real-time control device, the data display quantity and each piece of media data of the data display position to the real-time control device by sending a third message carrying the data display quantity of the data display position and each piece of media data.

Second step: The real-time control device receives the data display quantity of the data display position and at least one piece of media data that are sent by the device for displaying media data.

This embodiment does not limit the specific receiving manner of receiving, by the real-time control device, the data display quantity of the data display position and at least one piece of media data that are sent by the device for displaying media data. For example, the real-time control device receives the data display quantity of the data display position and at least one piece of media data that are sent by the device for displaying media data by receiving the third message that is sent by the device for displaying media data and carries the data display quantity of the data display position and at least one piece of media data.

Third step: The real-time control device acquires preset display times corresponding to each piece of media data.

For example, as shown in FIG. 1, the real-time control server 103 acquires the preset display times corresponding to each piece of media data from the front-end management system 104.

Fourth step: The real-time control device computes a recommendation smooth score corresponding to each piece of media data according to the data display quantity of the data display position and the preset display times corresponding to each piece of media data.

This embodiment does not limit the specific computing method for computing the recommendation smooth score corresponding to each piece of media data according to the data display quantity of the data display position and the preset display times of each piece of media data. The specific computing method includes, but is not limited to, computing the recommendation smooth score corresponding to each piece of media data according to the following formula:

$$recommendation smooth score [ i ] = \frac{{Σ}_{i = 1}^{N} display times [ i ]}{N \times display times [ i ]} ;$$

where the recommendation smooth score [i] is a recommendation smooth score corresponding to media data i, the display times [i] is preset display times corresponding to the media data i, and N is the data display quantity of the data display position.

Fifth step: The real-time control device sends the recommendation smooth score corresponding to each piece of media data to the device for displaying media data.

This embodiment does not limit the specific sending manner of sending, by the real-time control device, the recommendation smooth score corresponding to each piece of media data to the device for displaying media data. For example, the real-time control device sends the recommendation smooth score corresponding to each piece of media data to the device for displaying media data by sending, to the device for displaying media data, a fourth message carrying the recommendation smooth score corresponding to each piece of media data.

Sixth step: The device for displaying media data receives the recommendation smooth score corresponding to each piece of media data returned by the real-time control device.

This embodiment does not limit the specific receiving manner of receiving, by the device for displaying media data, the recommendation smooth score corresponding to each piece of media data returned by the real-time control device. For example, the device for displaying media data receives the recommendation smooth score corresponding to each piece of media data returned by the real-time control device by receiving the fourth message that is returned by the real-time control device and carries the recommendation smooth score corresponding to each piece of media data.

504: Select one piece of media data from all the media data according to the predicted click information and the predicted display information corresponding to each piece of media data, and display the selected media data on the data display position.

This embodiment does not limit the specific selecting method for selecting one piece of media data from all the media data according to the predicted click information and the predicted display information corresponding to each piece of media data. The specific selecting method includes, but is not limited to, selecting one piece of media data by using the following steps:

First step: Compute a display index value corresponding to each piece of media data according to the predicted click information and the predicted display information corresponding to each piece of media data.

This embodiment does not limit the specific computing method for computing the display index value corresponding to each piece of media data according to the predicted click information and the predicted display information corresponding to each piece of media data. The specific computing method includes, but is not limited to, computing the display index value corresponding to each piece of media data by using the following two sub-steps.

Sub-step 1: Acquire a predicted click information adjustment parameter α and a predicted display information adjustment parameter β.

This embodiment does not limit specific acquiring method for acquiring the predicted click information adjustment parameter α and the predicted display information adjustment parameter β. For example, if the predicted click information adjustment parameter α and the predicted display information adjustment parameter β are obtained while the model file is formed, the method for acquiring the predicted click information adjustment parameter α and the predicted display information adjustment parameter β varies when different specific devices are used to form the model file.

For example, if the specific device for forming the model file is the device for displaying media data, the predicted click information adjustment parameter α and the predicted display information adjustment parameter β obtained when the model file is formed are directly acquired from a database.

For another example, if the specific device for forming the model file is the predicting device, a fifth message for acquiring the predicted click information adjustment parameter α and the predicted display information adjustment parameter β is sent to the predicting device, so that the predicting device receives the fifth message, and acquires and returns the predicted click information adjustment parameter α and the predicted display information adjustment parameter β that are obtained when the model file is formed, and the device for displaying media data receives the predicted click information adjustment parameter α and the predicted display information adjustment parameter β returned by the predicting device.

Sub-step 2: Compute a display index value corresponding to each piece of media data according to the predicted click information and the predicted display information corresponding to each piece of media data based on the following formula:

F[i]=(predicted click information [i])^{α}×(predicted display information [i])^{β};

where F[i] is a display index value corresponding to media data i, the predicted click information [i] is predicted click information corresponding to the media data i, and the predicted display information [i] is predicted display information corresponding to the media data i.

Second step: Determine a largest display index value among all display index values corresponding to all the media data, and use media data corresponding to the largest display index value as the selected media data.

Still, by using the example in which the advertisement playing position C is provided, the predicted click information is the click-through rate lifting ratio, and the predicted display information is the recommendation smooth score, it is determined in step 502 that the click-through rate lifting ratio corresponding to the advertisement E is 0.67 and the click-through rate lifting ratio corresponding to the advertisement F is 1.33, and it is determined in step 503 that the recommendation smooth score corresponding to the advertisement E is 1.1 and the recommendation smooth score corresponding to the advertisement F is 0.92. If it is obtained in step 502 that the predicted click information adjustment parameter α=1 and the predicted display information adjustment parameter β=2, the display index value corresponding to the advertisement E is 0.67¹×1.1²=1.474 and the display index value corresponding to the advertisement F is 1.33¹×0.92²=1.13. Because 1.474 is greater than 1.13, the advertisement E Corresponding to 1.474 is used as the selected media data and the advertisement E is displayed on the advertisement playing position C.

Certainly, the recommendation smooth score corresponding to the advertisement E or the advertisement F may also be other values. This embodiment does not limit the specific recommendation smooth score corresponding to the advertisement E or the advertisement F. α or β may also be other values. This embodiment does not limit the specific value corresponding to α or β.

It should be noted that, when step 501 is performed, if a specific determining manner of determining all the media data corresponding to the data display position and then selecting at least one piece of media data from all the media data as the media data corresponding to the data display position is selected to determine, by the device for displaying media data, at least one piece of media data corresponding to the data display position, the media data displayed on the data display position in step 504 is only media data having the largest display index value among the media data selected in step 501. Because display index values of media data not selected in step 501 are not computed, a display index value of a piece of media data not selected may be greater than the display index value of the displayed media data, and as a result, the display result is not optimal. However, in step 501, the specific determining method that includes first step to third step is selected to by the device for displaying media data, at least one piece of media data corresponding to the data display position, and therefore, the number of pieces of media data for which the display index values need to be computed in step 504 is reduced, so that the display time is minimal.

When step 501 is performed, if a specific determining method of determining all the media data corresponding to the data display position and using all the media data corresponding to the data display position as the media data corresponding to the data display position is selected to determine, by the device for displaying media data, at least one piece of media data corresponding to the data display position, the media data displayed on the data display position in step 504 is the media data having the largest display index value among all the media data, so that the display result is optimal. However, because in step 501, a specific determining method of determining all the media data corresponding to the data display position and using all the media data corresponding to the data display position as the media data corresponding to the data display position is selected to determine, by the device for displaying media data, at least one piece of media data corresponding to the data display position, the number of pieces of media data for which the display index values need to be computed in step 504 is increased, and therefore, the display time is not minimal.

Therefore, in specific implementation of this embodiment of the present invention, the specific implementation manners of step 501 may be considered according to specific conditions of the implementation environment.

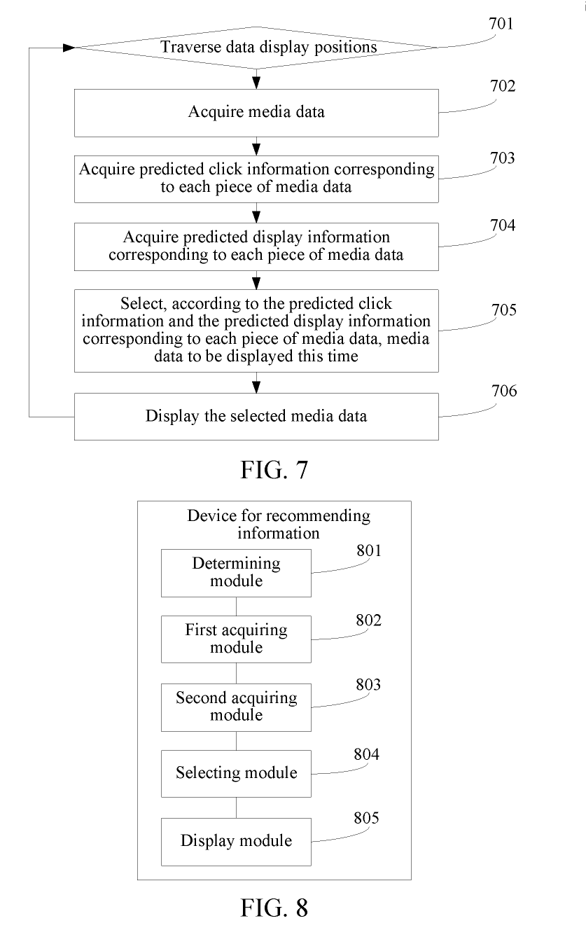

In addiction, to describe the process of executing the method provided in this embodiment by the device for displaying media data more clearly and straightforwardly, reference may be made to the schematic flowchart of the process of displaying media data by the device for displaying media data shown in FIG. 7 for details.

After determining one data display position for displaying media data by performing step 701: traverse data display positions, the device for displaying media data performs step 702 to step 705 to select media data for the determined data display position and performs step 706 to display the selected media data on the determined data display position. A specific process of selecting media data is: performing step 702 to acquire media data of the determined data display position, performing step 703 according to the media data acquired in step 702 to acquire predicted click information corresponding to each piece of media data, performing step 704 to acquire predicted display information corresponding to each piece of media data, and performing step 705 to select, according to the predicted click information and the predicted display information corresponding to each piece of media data, media data to be displayed this time. After selecting the media data for the determined data display position and displaying the selected media data on the determined data display position by using the foregoing process, step 701 is repeated to traverse data display positions to determine a next data display position for displaying media data. By repeating the steps sequentially, media data is selected for each data display position on which media data needs to be displayed, and the selected media data is displayed on the data display position on which media data needs to be displayed.

Certainly, the acquisition sequence of acquiring the predicted click information corresponding to each piece of media data and acquiring the predicted display information corresponding to each piece of media data may also be a sequence other than the sequence shown in FIG. 7. This embodiment does not limit the specific acquisition sequence of acquiring the predicted click information corresponding to each piece of media data and acquiring the predicted display information corresponding to each piece of media data.

Besides, this embodiment only uses an example in which the data display positions are the advertisement playing position A and the advertisement playing position B, the media data corresponding to the advertisement playing position A is the advertisement A and the advertisement B, and the media data corresponding to the advertisement playing position B is the advertisement C and the advertisement D. In addition, the name of the advertisement playing position may also be another name. This embodiment does not limit the specific name of the advertisement playing position. The media data corresponding to the advertisement playing position A may also be other media data. This embodiment does not limit the specific media data corresponding to the advertisement playing position A.

By selecting one piece of media data from all media data according to predicted click information and predicted display information corresponding to each piece of media data and displaying the selected media data on a data display position, the method provided in this embodiment ensures, by using the predicted click information corresponding to the media data, that a click-through rate obtained when the selected media data is displayed on the data display position is higher than a click-through rate obtained when any other piece of media data is displayed on the data display position, while ensuring, by using the predicted display information corresponding to the media data, that the total number of times each piece of media data is displayed is the same, so as to prevent a decrease in the click-through rate of the displayed media data due to that a current user is not interested in the media data displayed currently, thereby enhancing a display effect of the media data.

### Embodiment 3

This embodiment provides a device for displaying media data. The device is configured to perform the method for displaying media data provided in the foregoing Embodiment 1 or Embodiment 2. Referring to FIG. 8, the device includes:

a determining module 801, configured to determine at least one piece of media data corresponding to a data display position;

a first acquiring module 802, configured to acquire predicted click information corresponding to each piece of media data determined by the determining module 801;

a second acquiring module 803, configured to acquire predicted display information corresponding to each piece of media data determined by the determining module 801;

a selecting module 804, configured to select one piece of media data from all the media data according to the predicted click information and the predicted display information corresponding to each piece of media data; and

a display module 805, configured to display the media data selected by the selecting module 804 on the data display position.

The predicted click information corresponding to the media data is used for describing a display effect of the media data on the data display position, and the predicted display information corresponding to the media data is used for describing the number of times the media data is displayed on all data display positions.

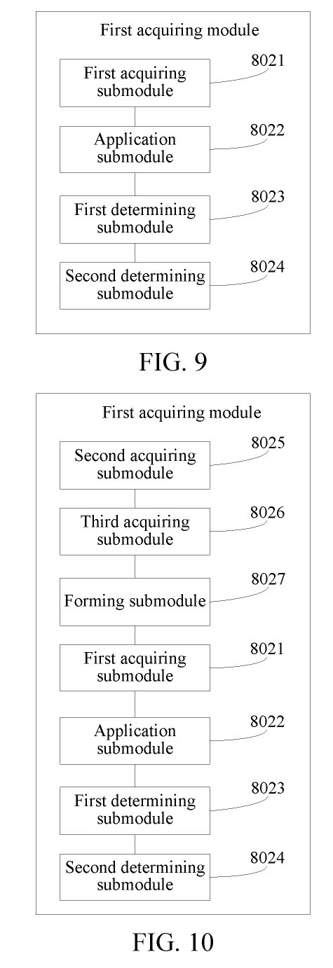

Referring to FIG. 9, the first acquiring module 802 includes:

a first acquiring submodule 8021, configured to acquire data display position information, user information, and a model file corresponding to the data display position;

an application submodule 8022, configured to apply the data display position information, the user information, and each piece of media data that are corresponding to the data display position as parameters to the model file to obtain a predicted click-through rate corresponding to each piece of media data;

a first determining submodule 8023, configured to determine an average click-through rate corresponding to the data display position according to the predicted click-through rate corresponding to each piece of media data obtained by the application submodule 8022; and

a second determining submodule 8024, configured to use a ratio of the predicted click-through rate corresponding to each piece of media data obtained by the application submodule 8022 to the average click-through rate corresponding to the data display position obtained by the first determining submodule 8023 as the predicted click information corresponding to each piece of media data.

The model file is used for obtaining, according to an associated feature among the data display position information, the media data, and the user information of the data display position, a predicted click-through rate relative to a user when the media data is displayed on the data display position.

Referring to FIG. 10, the first acquiring module 802 further includes:

a second acquiring submodule 8025, configured to acquire data display position information, historical displayed media data, and historical user information of each data display position;

a third acquiring submodule 8026, configured to acquire the associated feature among the data display position information, the media data, and the user information according to the data display position information, the historical displayed media data, and the historical user information of each data display position acquired by the second acquiring submodule 8025; and

a forming submodule 8027, configured to form a model file in which the data display position information, the media data, and the user information are used as parameters, the associated feature among the data display position information, the media data, and the user information is used as a model, and the predicted click-through rate relative to the user when the media data is displayed on the data display position is used as an output result.

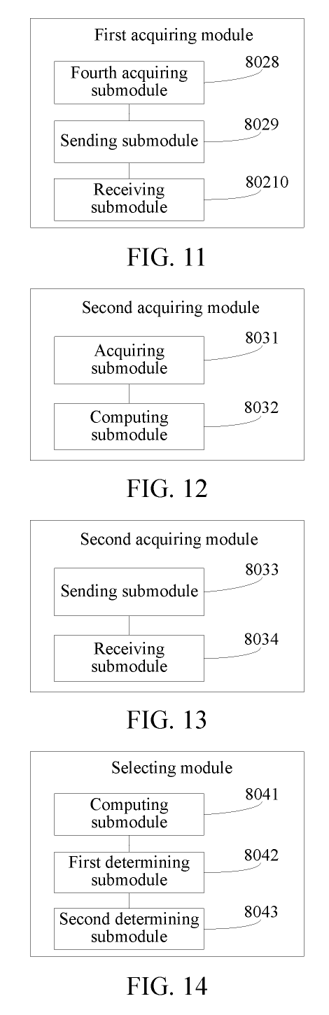

Referring to FIG. 11, the first acquiring module 802 includes:

a fourth acquiring submodule 8028, configured to acquire user information and data display position information that are corresponding to the data display position;

a sending submodule 8029, configured to send the user information, the data display position information, and each piece of media data that are corresponding to the data display position to a predicting device, so that the predicting device predicts and returns the predicted click information corresponding to each piece of media data according to the user information, the data display position information, and each piece of media data that are corresponding to the data display position; and

a receiving submodule 80210, configured to receive the predicted click information corresponding to each piece of media data returned by the predicting device.

Referring to FIG. 12, the second acquiring module 803 includes:

an acquiring submodule 8031, configured to acquire preset display times corresponding to each piece of media data; and

a computing submodule 8032, configured to compute the predicted display information corresponding to each piece of media data according to a data display quantity of the data display position and the preset display times corresponding to each piece of media data acquired by the acquiring submodule 8031.

The computing submodule 8032 is configured to compute the predicted display information corresponding to each piece of media data according to the data display quantity of the data display position and the preset display times of each piece of media data based on the following formula:

$$predicted display information [ i ] = \frac{{Σ}_{i = 1}^{N} display times [ i ]}{N \times display times [ i ]} ;$$

where the predicted display information [i] is predicted display information corresponding to media data i, the display times [i] is preset display times of the media data i, and N is the data display quantity of the data display position.

Referring to FIG. 13, the second acquiring module 803 includes:

a sending submodule 8033, configured to send the data display quantity of the data display position and each piece of media data to a real-time control device, so that the real-time control device determines and returns the predicted display information corresponding to each piece of media data according to the data display quantity of the data display position; and

a receiving submodule 8034, configured to receive the predicted display information corresponding to each piece of media data returned by the real-time control device.

Referring to FIG. 14, the selecting module 804 includes:

a computing submodule 8041, configured to compute a display index value corresponding to each piece of media data according to the predicted click information and the predicted display information corresponding to each piece of media data;

a first determining submodule 8042, configured to determine a largest display index value among all display index values corresponding to all the media data; and

a second determining submodule 8043, configured to use media data corresponding to the largest display index value as the selected media data.

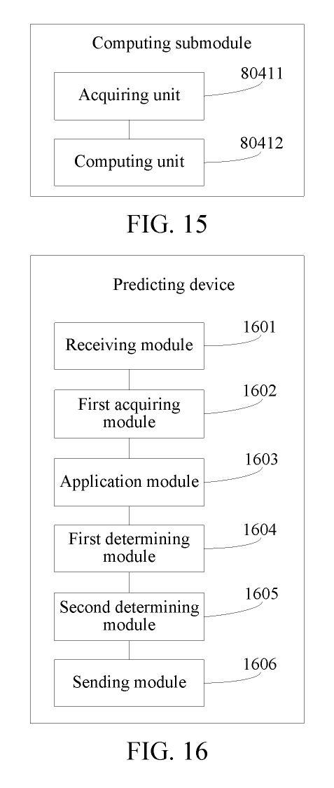

Referring to FIG. 15, the computing submodule 8041 includes:

an acquiring unit 80411, configured to acquire a predicted click information adjustment parameter α and a predicted display information adjustment parameter β; and

a computing unit 80412, configured to compute the display index value corresponding to each piece of media data according to the predicted click information and the predicted display information corresponding to each piece of media data based on the following formula:

F[i]=(predicted click information [i])^{α}×(predicted display information [i])^{β};

where F[i] is a display index value corresponding to media data i, the predicted click information [i] is predicted click information corresponding to the media data i, and the predicted display information [i] is predicted display information corresponding to the media data i.

By selecting one piece of media data from all media data according to predicted click information and predicted display information corresponding to each piece of media data and displays the selected media data on a data display position, the device provided in this embodiment ensures, by using the predicted click information corresponding to the media data, that a click-through rate obtained when the selected media data is displayed on the data display position is higher than a click-through rate obtained when any other piece of media data is displayed on the data display position, while ensuring, by using the predicted display information corresponding to the media data, that the total number of times each piece of media data is displayed is the same, so as to prevent a decrease in the click-through rate of the displayed media data due to that a current user is not interested in the media data displayed currently, thereby enhancing a display effect of the media data.

### Embodiment 4

This embodiment provides a predicting device for media data display. The predicting device is configured to perform the method for displaying media data provided in the foregoing Embodiment 1 or Embodiment 2. Referring to FIG. 16, the predicting device includes:

a receiving module 1601, configured to receive user information, data display position information, and at least one piece of media data that are sent by a device for displaying media data;

a first acquiring module 1602, configured to acquire a model file;

an application module 1603, configured to apply the user information, the data display position information, and each piece of media data received by the receiving module 1601 as parameters to the model file acquired by the first acquiring module 1602 to obtain a predicted click-through rate corresponding to each piece of media data;

a first determining module 1604, configured to determine an average click-through rate corresponding to the data display position according to the predicted click-through rate corresponding to each piece of media data obtained by the application module 1603;

a second determining module 1605, configured to use a ratio of the predicted click-through rate corresponding to each piece of media data obtained by the application module 1603 to the average click-through rate corresponding to the data display position obtained by the first determining module 1604 as predicted click information corresponding to each piece of media data, respectively; and

a sending module 1606, configured to send the predicted click information corresponding to each piece of media data obtained by the second determining module 1605 to the device for displaying media data, so that the device for displaying media data selects one piece of media data from all the media data according to the predicted click information corresponding to each piece of media data and displays the selected media data on the data display position.

The model file is used for obtaining, according to an associated feature among the data display position information, the media data, and the user information of the data display position, a predicted click-through rate relative to a user when the media data is displayed on the data display position.

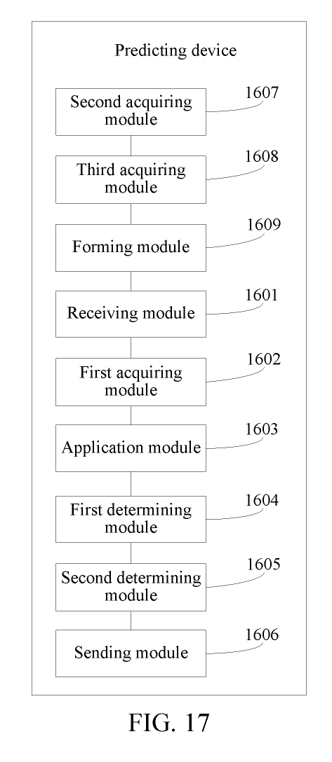

Referring to FIG. 17, the predicting device further includes:

a second acquiring module 1607, configured to acquire data display position information, historical displayed media data, and historical user information of each data display position;

a third acquiring module 1608, configured to acquire the associated feature among the data display position information, the media data, and the user information according to the data display position information, the historical displayed media data, and the historical user information of each data display position acquired by the second acquiring module 1607; and

a forming module 1609, configured to form a model file in which the data display position information, the media data, and the user information are used as parameters, the associated feature among the data display position information, the media data, and the user information is used as a model, and the predicted click-through rate relative to the user when the media data is displayed on the data display position is used as an output result.

By receiving user information, data display position information, and at least one piece of media data that are sent by the device for displaying media data and then acquiring and returning predicted click information corresponding to each piece of media data according to the received user information, data display position information, and at least one piece of media data, so that the device for displaying media data selects one piece of media data from all the media data according to the predicted click information corresponding to each piece of media data and displays the selected media data on the data display position, the predicting device provided in this embodiment ensures, by using the predicted click information corresponding to the media data, that a click-through rate obtained when the selected media data is displayed on the data display position is higher than a click-through rate obtained when any other piece of media data is displayed on the data display position, so as to prevent a decrease in the click-through rate of the displayed media data due to that a current user is not interested in the media data displayed currently, thereby enhancing a display effect of the media data.

### Embodiment 5

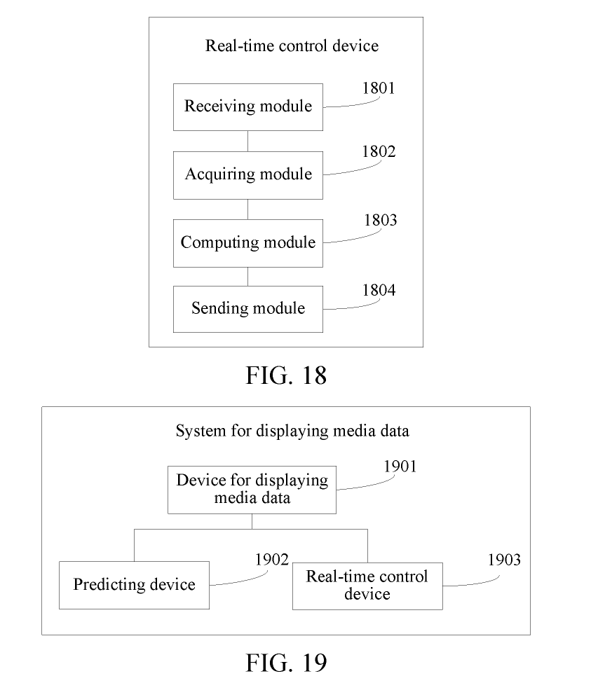

This embodiment provides a real-time control device for media data display. The real-time control device is configured to perform the method for displaying media data provided in the foregoing Embodiment 1 or Embodiment 2. Referring to FIG. 18, the real-time control device includes:

a receiving module 1801, configured to receive a data display quantity of a data display position and at least one piece of media data that are sent by a device for displaying media data;

an acquiring module 1802, configured to acquire preset display times corresponding to each piece of media data;

a computing module 1803, configured to compute predicted display information corresponding to each piece of media data according to the data display quantity of the data display position and the preset display times corresponding to each piece of media data; and

a sending module 1804, configured to send the predicted display information corresponding to each piece of media data obtained by the computing module 1803 to the device for displaying media data, so that the device for displaying media data selects one piece of media data from all the media data according to the predicted display information corresponding to each piece of media data and displays the selected media data on the data display position.

The computing module 1803 is configured to compute a recommendation smooth score corresponding to each piece of media data according to the data display quantity of the data display position and the preset display times of each piece of media data based on the following formula:

$$predicted display information [ i ] = \frac{{Σ}_{i = 1}^{N} display times [ i ]}{N \times display times [ i ]} ;$$

where the predicted display information [i] is predicted display information corresponding to media data i, the display times [i] is preset display times of the media data i, and N is the data display quantity of the data display position.

By receiving a data display quantity of a data display position and at least one piece of media data that are sent by a device for displaying media data, and then acquiring and returning predicted display information corresponding to each piece of media data according to the received data display quantity of the data display position and at least one piece of media data, so that the device for displaying media data selects one piece of media data from all the media data according to the predicted display information corresponding to each piece of media data and displays the selected media data on the data display position, the real-time control device provided in this embodiment ensures, by using the predicted display information corresponding to the media data, that the number of times each piece of media data is displayed on the data display position is the same.

### Embodiment 6

This embodiment provides a system for displaying media data. The system is configured to perform the method for displaying media data provided in the foregoing Embodiment 1 or Embodiment 2. Referring to FIG. 19, the system includes:

a device 1901 for displaying media data, a predicting device 1902, and a real-time control device 1903.

The device 1901 for displaying media data is the device provided in the foregoing Embodiment 3. Refer to the foregoing Embodiment 3 for details.

The predicting device 1902 is the predicting device provided in the foregoing Embodiment 4. Refer to the foregoing Embodiment 4 for details.

The real-time control device 1903 is the real-time control device provided in the foregoing Embodiment 5. Refer to the foregoing Embodiment 5 for details.

By selecting one piece of media data from all media data according to predicted click information and predicted display information corresponding to each piece of media data and displaying the selected media data on a data display position, the system provided in this embodiment ensures, by using the predicted click information corresponding to the media data, a click-through rate obtained when the selected media data is displayed on the data display position is higher than a click-through rate obtained when any other piece of media data is displayed on the data display position, while ensuring, by using the predicted display information corresponding to the media data, that the total number of times each piece of media data is displayed is the same, so as to prevent a decrease in the click-through rate of the displayed media data due to that a current user is not interested in the media data displayed currently, thereby enhancing a display effect of the media data.

### Embodiment 7

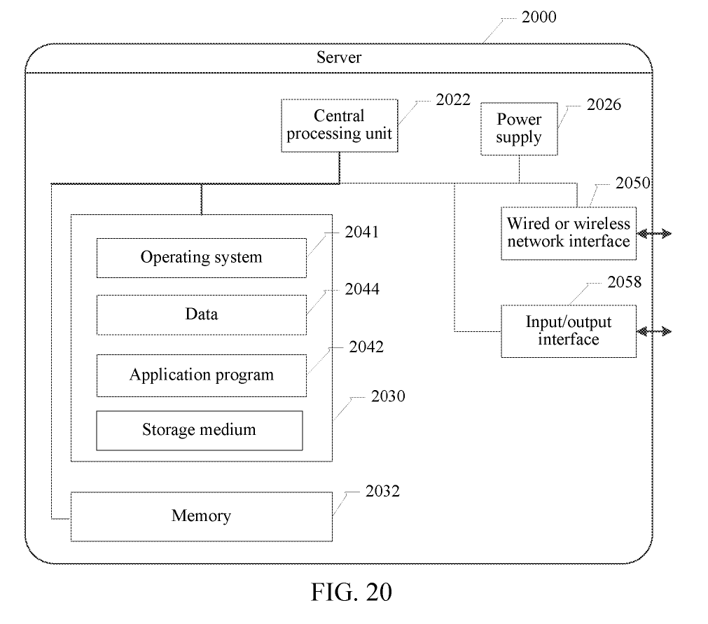

This embodiment provides a server for displaying media data. The server for displaying media data can be configured to perform the method for displaying media data provided in the foregoing Embodiment 1 or Embodiment 2. Specifically, referring to FIG. 20, the server 2000 may vary significantly due to different configurations or performance, and may include one or more central processing units (CPUs) 2022 (for example, one or more processors), a memory 2032, and one or more storage media 2030 (for example, one or more mass storage devices) for storing an application program 2042 or data 2044. The memory 2032 and the storage medium 2030 may be transient or permanent storage. The program stored in the storage medium 2030 may include one or more modules (not shown in the figure).

The server 2000 may further include one or more power supplies 2026, one or more wired or wireless network interfaces 2050, one or more input/output interfaces 2058, and/or one or more operating systems 2041, such as Windows Server™, Mac OS X™, Unix™, Linux™, and FreeBSD™.

One or more programs are stored in the memory and are configured to be performed by one or more processors. The one or more programs include instructions for executing the following operations:

determining at least one piece of media data corresponding to a data display position;

acquiring predicted click information and predicted display information corresponding to each piece of media data, and

selecting one piece of media data from all the media data according to the predicted click information and the predicted display information corresponding to each piece of media data, and displaying the selected media data on the data display position.

The predicted click information corresponding to the media data is used for describing a display effect of the media data on the data display position, and the predicted display information corresponding to the media data is used for describing the number of times the media data is displayed on all data display positions.

Assuming that the foregoing is a first possible implementation manner, a second possible implementation manner provided on the basis of the first possible implementation manner further includes instructions for executing the following operations:

acquiring data display position information, user information, and a model file that are corresponding to the data display position;

applying the data display position information, the user information, and each piece of media data that are corresponding to the data display position as parameters to the model file to obtain a predicted click-through rate corresponding to each piece of media data, and determining an average click-through rate corresponding to the data display position according to the predicted click-through rate corresponding to each piece of media data; and

using a ratio of the predicted click-through rate corresponding to each piece of media data to the average click-through rate corresponding to the data display position as the predicted click information corresponding to each piece of media data.

The model file is used for obtaining, according to an associated feature among the data display position information, the media data, and the user information of the data display position, a predicted click-through rate relative to a user when the media data is displayed on the data display position.

A third possible implementation manner provided on the basis of the second possible implementation manner further includes instructions for executing the following operations:

acquiring data display position information, historical displayed media data, and historical user information of each data display position; and

acquiring the associated feature among the data display position information, the media data, and the user information according to the data display position information, the historical displayed media data, and the historical user information of each data display position, and forming a model file in which the data display position information, the media data, and the user information are used as parameters, the associated feature among the data display position information, the media data, and the user information is used as a model and the predicted click-through rate relative to the user when the media data is displayed on the data display position is used as an output result.

A fourth possible implementation manner provided on the basis of the first possible implementation manner further includes instructions for executing the following operations:

acquiring user information and data display position information that are corresponding to the data display position;

sending the user information, the data display position information, and each piece of media data that are corresponding to the data display position to a predicting device, so that the predicting device predicts and returns the predicted click information corresponding to each piece of media data according to the user information, the data display position information, and each piece of media data that are corresponding to the data display position; and

receiving the predicted click information corresponding to each piece of media data returned by the predicting device.

A fifth possible implementation manner provided on the basis of the first possible implementation manner further includes instructions for executing the following operations:

acquiring preset display times of each piece of media data; and

computing the predicted display information corresponding to each piece of media data according to a data display quantity of the data display position and the preset display times of each piece of media data.

A sixth possible implementation manner provided on the basis of the fifth possible implementation manner further includes instructions for executing the following operations:

computing the predicted display information corresponding to each piece of media data according to the data display quantity of the data display position and the preset display times of each piece of media data based on the following formula:

$$predicted display information [ i ] = \frac{{Σ}_{i = 1}^{N} display times [ i ]}{N \times display times [ i ]} ;$$

where the predicted display information [i] is predicted display information corresponding to media data i, the display times [i] is preset display times of the media data i, and N is the data display quantity of the data display position.

A seventh possible implementation manner provided on the basis of the first possible implementation manner further includes instructions for executing the following operations:

sending a data display quantity of the data display position and each piece of media data to a real-time control device, so that the real-time control device determines and returns the predicted display information corresponding to each piece of media data according to the data display quantity of the data display position; and

receiving the predicted display information corresponding to each piece of media data returned by the real-time control device.

An eighth possible implementation manner provided on the basis of the first possible implementation manner further includes instructions for executing the following operations:

computing a display index value corresponding to each piece of media data according to the predicted click information and the predicted display information corresponding to each piece of media data; and

determining a largest display index value among all display index values corresponding to all the media data, and using media data corresponding to the largest display index value as the selected media data.

A ninth possible implementation manner provided on the basis of the eighth possible implementation manner further includes instructions for executing the following operations:

acquiring a predicted click information adjustment parameter α and a predicted display information adjustment parameter β; and

computing the display index value corresponding to each piece of media data according to the predicted click information and the predicted display information corresponding to each piece of media data based on the following formula:

F[i]=(predicted click information [i])^{α}×(predicted display information [i])^{β};

where F[i] is a display index value corresponding to media data i, the predicted click information [i] is predicted click information corresponding to the media data i, and the predicted display information [i] is predicted display information corresponding to the media data i.

To sum up, by selecting one piece of media data from all media data according to predicted click information and predicted display information corresponding to each piece of media data, and displaying the selected media data on a data display position, the server provided in this embodiment ensures, by using the predicted click information corresponding to the media data, that a click-through rate obtained when the selected media data is displayed on the data display position is higher than a click-through rate obtained when any other piece of media data is displayed on the data display position, while ensuring, by using the predicted display information corresponding to the media data, the total number of times each piece of media data is displayed is the same, so as to prevent a decrease in the click-through rate of the displayed media data due to that a current user is not interested in the media data displayed currently, thereby enhancing a display effect of the media data.

It should be noted that, when implementing display of media data, the device for displaying media data, the predicting device, and the real-time control device provided in the foregoing embodiments are described by using an example of the foregoing division of the functional modules, and in actual applications, the foregoing functions may be implemented by different functional modules as required, that is, the internal structures of the device for displaying media data, the predicting device, and the real-time control device are divided into different functional modules so as to implement all or some of the described functions. Besides, the device for displaying media data, the predicting device, the real-time control device, the system, and the method for displaying media data provided in the foregoing embodiments belong to the same concept, and for details of the specific implementation process, reference may be made to the method embodiments, which are not described again herein.

The sequence numbers of the foregoing embodiments of the present invention are merely for the convenience of description, and do not imply the preference among the embodiments.

A person of ordinary skill in the art may understand that all or some of the steps of the foregoing embodiments may be implemented by using hardware, or may be implemented by a program instructing relevant hardware. The program may be stored in a computer readable storage medium. The storage medium may be a read-only memory, a magnetic disk, an optical disc, or the like.

The above descriptions are merely preferred embodiments of the present invention, and are not intended to limit the present disclosure. Any modification, equivalent replacement, or improvement made within the spirit and principle of the present disclosure shall fall within the protection scope of the present disclosure.

1. A method for displaying media data, comprising:
determining at least one piece of media data corresponding to a data display position;
acquiring predicted click information and predicted display information corresponding to each piece of media data; and
selecting one piece of media data from all the media data according to the predicted click information and the predicted display information corresponding to each piece of media data and displaying the selected media data on the data display position;
the predicted click information corresponding to the media data being used for describing a display effect of the media data on the data display position, and the predicted display information corresponding to the media data being used for describing the number of times the media data is displayed on all data display positions.

2. The method according to claim 1, wherein the acquiring predicted click information corresponding to each piece of media data comprises:
acquiring data display position information, user information, and a model file that are corresponding to the data display position;
applying the data display position information, the user information, and each piece of media data that are corresponding to the data display position as parameters to the model file to obtain a predicted click-through rate corresponding to each piece of media data, and determining an average click-through rate corresponding to the data display position according to the predicted click-through rate corresponding to each piece of media data; and
using a ratio of the predicted click-through rate corresponding to each piece of media data to the average click-through rate corresponding to the data display position as the predicted click information corresponding to each piece of media data;
wherein the model file is used for obtaining, according to an associated feature among the data display position information, the media data, and the user information of the data display position, a predicted click-through rate relative to a user when the media data is displayed on the data display position.

3. The method according to claim 2, wherein before the acquiring data display position information, user information, and a model file that are corresponding to the data display position, the method further comprises:
acquiring data display position information, historical displayed media data, and historical user information of each data display position; and
acquiring the associated feature among the data display position information, the media data, and the user information according to the data display position information, the historical displayed media data, and the historical user information of each data display position, and forming a model file in which the data display position information, the media data, and the user information are used as parameters, the associated feature among the data display position information, the media data, and the user information is used as a model, and the predicted click-through rate relative to the user when the media data is displayed on the data display position is used as an output result.

4. The method according to claim 1, wherein the acquiring predicted click information corresponding to each piece of media data comprises:
acquiring user information and data display position information that are corresponding to the data display position;
sending the user information, the data display position information, and each piece of media data that are corresponding to the data display position to a predicting device, so that the predicting device predicts and returns the predicted click information corresponding to each piece of media data according to the user information, the data display position information, and each piece of media data that are corresponding to the data display position; and
receiving the predicted click information corresponding to each piece of media data returned by the predicting device.

5. The method according to claim 1, wherein the acquiring predicted display information corresponding to each piece of media data comprises:
acquiring preset display times of each piece of media data; and
computing the predicted display information corresponding to each piece of media data according to a data display quantity of the data display position and the preset display times of each piece of media data.

6. The method according to claim 5, wherein the computing the predicted display information corresponding to each piece of media data according to a data display quantity of the data display position and the preset display times of each piece of media data comprises:
computing the predicted display information corresponding to each piece of media data according to the data display quantity of the data display position and the preset display times of each piece of media data based on the following formula:
$$predicted display information [ i ] = \frac{{Σ}_{i = 1}^{N} display times [ i ]}{N \times display times [ i ]} ;$$
wherein the predicted display information [i] is predicted display information corresponding to media data i, the display times [i] is preset display times corresponding to the media data i, and N is the data display quantity corresponding to the data display position.

7. The method according to claim 1, wherein the acquiring predicted display information corresponding to each piece of media data comprises:
sending a data display quantity of the data display position and each piece of media data to a real-time control device, so that the real-time control device determines and returns the predicted display information corresponding to each piece of media data according to the data display quantity of the data display position; and
receiving the predicted display information corresponding to each piece of media data returned by the real-time control device.

8. The method according to claim 1, wherein the selecting media data from all the media data according to the predicted click information and the predicted display information corresponding to each piece of media data comprises:
computing a display index value corresponding to each piece of media data according to the predicted click information and the predicted display information corresponding to each piece of media data; and
determining a largest display index value among all display index values corresponding to all the media data, and using media data corresponding to the largest display index value as the selected media data.

9. The method according to claim 8, wherein the computing a display index value corresponding to each piece of media data according to the predicted click information and the predicted display information corresponding to each piece of media data comprises:
acquiring a predicted click information adjustment parameter α and a predicted display information adjustment parameter β; and
computing the display index value corresponding to each piece of media data according to the predicted click information and the predicted display information corresponding to each piece of media data based on the following formula:
F[i]=(predicted click information [i])^{α}×(predicted display information [i])^{β};
wherein F[i] is a display index value corresponding to media data i, the predicted click information [i] is predicted click information corresponding to the media data i, and the predicted display information [i] is predicted display information corresponding to the media data i.

10. A device for displaying media data, comprising:
a determining module, configured to determine at least one piece of media data corresponding to a data display position;
a first acquiring module, configured to acquire predicted click information corresponding to each piece of media data determined by the determining module;
a second acquiring module, configured to acquire predicted display information corresponding to each piece of media data determined by the determining module;
a selecting module, configured to select one piece of media data from all the media data according to the predicted click information and the predicted display information corresponding to each piece of media data; and
a display module, configured to display the media data selected by the selecting module on the data display position;
the predicted click information corresponding to the media data being used for describing a display effect of the media data on the data display position, and the predicted display information corresponding to the media data being used for describing the number of times the media data is displayed on all data display positions.

11. The device according to claim 10, wherein the first acquiring module comprises:
a first acquiring submodule, configured to acquire data display position information, user information, and a model file that are corresponding to the data display position;
an application submodule, configured to apply the data display position information, the user information, and each piece of media data that are corresponding to the data display position as parameters to the model file to obtain a predicted click-through rate corresponding to each piece of media data;
a first determining submodule, configured to determine an average click-through rate corresponding to the data display position according to the predicted click-through rate corresponding to each piece of media data obtained by the application submodule; and
a second determining submodule, configured to use a ratio of the predicted click-through rate corresponding to each piece of media data obtained by the application submodule to the average click-through rate corresponding to the data display position obtained by the first determining submodule as the predicted click information corresponding to each piece of media data;
wherein the model file is used for obtaining, according to an associated feature among the data display position information, the media data, and the user information of the data display position, a predicted click-through rate relative to a user when the media data is displayed on the data display position.

12. The device according to claim 11, wherein the first acquiring module further comprises:
a second acquiring submodule, configured to acquire data display position information, historical displayed media data, and historical user information of each data display position;
a third acquiring submodule, configured to acquire the associated feature among the data display position information, the media data, and the user information according to the data display position information, the historical displayed media data, and the historical user information of each data display position obtained by the second acquiring submodule; and
a forming submodule, configured to form a model file in which the data display position information, the media data, and the user information are used as parameters, the associated feature among the data display position information, the media data, and the user information is used as a model, and the predicted click-through rate relative to the user when the media data is displayed on the data display position is used as an output result.

13. The device according to claim 10, wherein the first acquiring module comprises:
a fourth acquiring submodule, configured to acquire user information and data display position information that are corresponding to the data display position;
a sending submodule, configured to send the user information, the data display position information, and each piece of media data that are corresponding to the data display position to a predicting device, so that the predicting device predicts and returns the predicted click information corresponding to each piece of media data according to the user information, the data display position information, and each piece of media data that are corresponding to the data display position; and
a receiving submodule, configured to receive the predicted click information corresponding to each piece of media data returned by the predicting device.

14. The device according to claim 10, wherein the second acquiring module comprises:
an acquiring submodule, configured to acquire preset display times of each piece of media data; and
a computing submodule, configured to compute predicted display information corresponding to each piece of media data according to a data display quantity of the data display position and the preset display times of each piece of media data acquired by the acquiring submodule.

15. The device according to claim 14, wherein the computing submodule is configured to compute the predicted display information corresponding to each piece of media data according to the data display quantity of the data display position and the preset display times of each piece of media data based on the following formula:
$$predicted display information [ i ] = \frac{{Σ}_{i = 1}^{N} display times [ i ]}{N \times display times [ i ]} ;$$
wherein the predicted display information [i] is predicted display information corresponding to media data i, the display times [i] is preset display times of the media data i, and N is the data display quantity of the data display position.

16. The device according to claim 10, wherein the second acquiring module comprises:
a sending submodule, configured to send a data display quantity of the data display position and each piece of media data to a real-time control device, so that the real-time control device determines and returns the predicted display information corresponding to each piece of media data according to the data display quantity of the data display position; and
a receiving submodule, configured to receive the predicted display information corresponding to each piece of media data returned by the real-time control device.

17. The device according to claim 10, wherein the selecting module comprises:
a computing submodule, configured to compute a display index value corresponding to each piece of media data according to the predicted click information and the predicted display information corresponding to each piece of media data;
a first determining submodule, configured to determine a largest display index value among all display index values corresponding to all the media data; and
a second determining submodule, configured to use media data corresponding to the largest display index value as the selected media data.

18. The device according to claim 17, wherein the computing submodule comprises:
an acquiring unit, configured to acquire a predicted click information adjustment parameter α and a predicted display information adjustment parameter β; and
a computing unit, configured to compute the display index value corresponding to each piece of media data according to the predicted click information and the predicted display information corresponding to each piece of media data based on the following formula:
F[i]=(predicted click information [i])^{α}×(predicted display information [i])^{β};
wherein F[i] is a display index value corresponding to media data i, the predicted click information [i] is predicted click information corresponding to the media data i, and the predicted display information [i] is predicted display information corresponding to the media data i.

19. A method for displaying media data, comprising:
receiving user information, data display position information, and at least one piece of media data that are sent by a device for displaying media data, and acquiring a model file;
applying the user information, the data display position information, and each piece of media data as parameters to the model file to obtain a predicted click-through rate corresponding to each piece of media data, and determining an average click-through rate corresponding to the data display position according to the predicted click-through rate corresponding to each piece of media data;
using a ratio of the predicted click-through rate corresponding to each piece of media data to the average click-through rate corresponding to the data display position as the predicted click information corresponding to each piece of media data; and
sending the predicted click information corresponding to each piece of media data to the device for displaying media data, so that the device for displaying media data selects one piece of media data from all the media data according to the predicted click information corresponding to each piece of media data and displays the selected media data on the data display position;
the model file being used for obtaining, according to an associated feature among the data display position information, the media data, and the user information of the data display position, a predicted click-through rate relative to a user when the media data is displayed on the data display position.

20. The method according to claim 19, before the acquiring a model file, further comprising:
acquiring data display position information, historical displayed media data, and historical user information of each data display position; and
acquiring the associated feature among the data display position information, the media data, and the user information according to the data display position information, the historical displayed media data, and the historical user information of each data display position, and forming a model file in which the data display position information, the media data, and the user information are used as parameters, the associated feature among the data display position information, the media data, and the user information is used as a model, and the predicted click-through rate relative to the user when the media data is displayed on the data display position is used as an output result.

21. A predicting device for media data display, comprising:
a receiving module, configured to receive user information, data display position information, and at least one piece of media data that are sent by a device for displaying media data;
a first acquiring module, configured to acquire a model file;
an application module, configured to apply the user information, the data display position information, and each piece of media data received by the receiving module as parameters to the model file acquired by the first acquiring module, to obtain a predicted click-through rate corresponding to each piece of media data;
a first determining module, configured to determine an average click-through rate corresponding to a data display position according to the predicted click-through rate corresponding to each piece of media data obtained by the application module;
a second determining module, configured to use a ratio of the predicted click-through rate corresponding to each piece of media data obtained by the application module to the average click-through rate corresponding to the data display position obtained by the first determining module as predicted click information corresponding to each piece of media data; and
a sending module, configured to send the predicted click information corresponding to each piece of media data obtained by the second determining module to the device for displaying media data, so that the device for displaying media data selects one piece of media data from all the media data according to the predicted click information corresponding to each piece of media data and displays the selected media data on the data display position;
the model file being used for obtaining, according to an associated feature among the data display position information, the media data, and the user information of the data display position, a predicted click-through rate relative to a user when the media data is displayed on the data display position.

22. The predicting device according to claim 21, wherein the predicting device further comprises:
a second acquiring module, configured to acquire data display position information, historical displayed media data, and historical user information of each data display position;
a third acquiring module, configured to acquire the associated feature among the data display position information, the media data, and the user information according to the data display position information, the historical displayed media data, and the historical user information of each data display position acquired by the second acquiring module; and
a forming module, configured to form a model file in which the data display position information, the media data, and the user information are used as parameters, the associated feature among the data display position information, the media data, and the user information is used as a model, and the predicted click-through rate relative to the user when the media data is displayed on the data display position is used as an output result.

23. A method for displaying media data, comprising:
receiving a data display quantity of a data display position and at least one piece of media data that are sent by a device for displaying media data;
acquiring preset display times of each piece of media data;
computing predicted display information corresponding to each piece of media data according to the data display quantity of the data display position and the preset display times of each piece of media data; and
sending the predicted display information corresponding to each piece of media data to the device for displaying media data, so that the device for displaying media data selects one piece of media data from all the media data according to the predicted display information corresponding to each piece of media data and displays the selected media data on the data display position.

24. The method according to claim 23, wherein the computing predicted display information corresponding to each piece of media data according to the data display quantity of the data display position and the preset display times of each piece of media data comprises:
computing the predicted display information corresponding to each piece of media data according to the data display quantity of the data display position and the preset display times of each piece of media data based on the following formula:
$$predicted display information [ i ] = \frac{{Σ}_{i = 1}^{N} display times [ i ]}{N \times display times [ i ]} ;$$
wherein the predicted display information [i] is predicted display information corresponding to media data i, the display times [i] is preset display times of the media data i, and N is the data display quantity of the data display position.

25. A real-time control device for media data display, comprising:
a receiving module, configured to receive a data display quantity of a data display position and at least one piece of media data that are sent by a device for displaying media data;
an acquiring module, configured to acquire preset display times of each piece of media data;
a computing module, configured to compute predicted display information corresponding to each piece of media data according to the data display quantity of the data display position and the preset display times of each piece of media data; and
a sending module, configured to send the predicted display information corresponding to each piece of media data obtained by the computing module to the device for displaying media data, so that the device for displaying media data selects one piece of media data from all the media data according to the predicted display information corresponding to each piece of media data and displays the selected media data on the data display position.

26. The real-time control device according to claim 25, wherein the computing module is configured to compute the predicted display information corresponding to each piece of media data according to the data display quantity of the data display position and the preset display times of each piece of media data based on the following formula:
$$predicted display information [ i ] = \frac{{Σ}_{i = 1}^{N} display times [ i ]}{N \times display times [ i ]} ;$$
wherein the predicted display information [i] is predicted display information corresponding to media data i, the display times [i] is preset display times of the media data i, and N is the data display quantity of the data display position.

27. A system for displaying media data, comprising: a device for displaying media data, a predicting device, and a real-time control device;
the device for displaying media data being the device for displaying media data according to claim 10, the predicting device being the predicting device for media data display according to claim 21, and the real-time control device being the real-time control device for media data display according to claim 25.
